(19) United States
(12) Patent Application Publication
(10) Pub. No.: US 2008/0135168 A1
(43) Pub. Date: Jun. 12, 2008

(54) Method for bonding together at least two sheets

(76) Inventor: Florian Knell, Eberhardzell (DE)

Correspondence Address: Krieg DeVault LLP;John H. Allie, Suite 2800, One Indiana Square, Indianapolis, IN, 46204, US

(21) Appl. No.: 11/978,240

(22) Filed: Oct. 26, 2007

Related U.S. Application Data
(63) Continuation of application No. PCT/EP2005/004470, filed on Apr. 26, 2005.

(51) Int. Cl. B32B 37/00; A63F 3/00; A63F 9/08

(52) U.S. Cl. 156/250; 156/60; 273/153 R; 273/287

(57) ABSTRACT

A method for bonding together at least two sheets, in particular for producing a puzzle, of which a first sheet consists of cardboard or paperboard and a second sheet consists of paper or cardboard, comprises the steps of transporting the first sheet to a gluing station, applying a synthetic hot melt to the first sheet in the gluing station in the liquid state, bringing together the first sheet coated with the synthetic hot melt and the second sheet in an aligning station, and pressing the two sheets together to form a finished laminated product. The finished laminated product can be rapidly further processed and is distinguished by excellent flatness.

The present invention relates to a method for bonding (glueing) together at least two sheets, wherein a first sheet consists of cardboard or paperboard and a second sheet consists of paper or cardboard. A method of this kind is used, for example, when producing a puzzle, a game plan for a table game or when producing games components such as, e.g. playing cards. Methods of this kind are also called laminating methods.

A cold glue is used for bonding in conventional laminating methods, in which a sheet consisting of cardboard or paperboard is glued to a sheet consisting of paper or cardboard, for example to produce laminated products which are to be subsequently further processed into puzzles or game plans. A cold glue of this kind is a dispersion glue which is processed at room temperature and which consists of plastics particles, e.g. polymers with a particle size of <5 μm, which are finely dispersed in water. The solids content of the dispersion glue is usually between 50 and 60%. Dispersion glue is physiologically harmless (important for games products) and reasonably priced. However products consisting or cardboard or paperboard and paper which are laminated with cold glue entail a problem which is described by the term “dishing” or “plate effect”. This means that the finished laminated product is not flat after the drying process, which is of relatively long duration, but that its edges are bent upwards to a greater or lesser extent. This “plate effect” leads to losses in terms of further processing as well as customer complaints and therefore has a negative influence on the quality of the end product.

In order to solve the above-mentioned problem, attempts have been made to prepare the first sheet consisting of cardboard or paperboard so that it arches opposite to the expected subsequent “plate effect”. Although the above-mentioned problem could be reduced in this way, it could not be eliminated.

The object of the invention is therefore to indicate a method for bonding a first sheet consisting of cardboard or paperboard to a second sheet consisting of paper or cardboard in which the finished laminated product is of improved flatness.

This object is achieved according to the invention by a method having the features which are mentioned in claim 1. In this method a first sheet consisting of cardboard or paperboard is transported to a gluing station, then a synthetic hot glue, frequently called “hot melt”, is applied to the first sheet in the gluing station in the liquid state and immediately afterwards the first sheet coated with the synthetic hot glue and a second sheet consisting of paper or cardboard are brought together in an aligning station and then pressed together in order to form the finished laminated product. The finished laminated product is distinguished by excellent flatness, at least if the actual sheets which are to be bonded together are flat before bonding. As a result, further processing with substantially fewer losses and, as a whole, a considerable increase in the quality of the end products which are obtained from the products which are finish-laminated using the method according to the invention are achieved.

A further advantage of the method according to the invention lies in the enormous shortening of the time required to produce an end product, for example a puzzle or game plan, for in the case of the conventional method which uses cold glue the laminated product produced by bonding together two sheets must dry for 12 to 48 hours, according to the room temperature and the selected stacking mode, before further processing, e.g. stamping into regularly or irregularly shaped individual parts, can take place. However, in the case of laminated products which have been produced using the method according to the invention, appropriate further processing can take place shortly after pressing the two sheets together. The maximum waiting time up to further processing is 30 minutes, for it is then at the latest that the synthetic hot glue which is used has completely crystallised. By using the method according to the invention it is therefore possible for manufacturing to respond in a distinctly quicker and more flexible manner to customer requirements, and end products can reach the distribution stage far quicker than has hitherto been the case.

Moreover, the quantity of glue which is used in the method according to the invention is substantially smaller than in the case of conventional methods using cold glue, so that, according to the invention, in spite of the significantly higher price of hot glue (hot glue is approximately twice as expensive as cold glue), the costs of the end product do not in any case rise or can even be reduced.

In the simplest embodiment of the method according to the invention one side of the first sheet consisting of cardboard or paperboard is stuck to a second sheet consisting of paper or cardboard. However, if desired, the other side of the first sheet can also be stuck to a third sheet which, like the second sheet, consists of paper or cardboard. For this purpose a synthetic hot glue is applied in the liquid state also to the other side which is opposite the one side of the first sheet, then the first sheet coated in such a way with hot glue is brought together with the third sheet in an aligning station and, finally, the first sheet and the third sheet are pressed together in order to bond them together. It is usual for the first sheet and the second sheet to be firstly bonded together and only then for the third sheet to be laminated onto the other side of the first sheet. Edges of the second sheet can in this way be turned over the peripheries of the first sheet and stuck before the third sheet is laminated on. If the first sheet is a bottom sheet and the second sheet a top sheet, the third sheet is then called a mirror, which covers the underside of the first sheet in the finished laminated product.

According to a preferred development of the method according to the invention, the synthetic hot glue is applied to the first sheet at a temperature in the range of approximately 150° C. to approximately 180° C. An application in the liquid state and, in additions satisfactory flowing of the applied synthetic hot glue on the first sheet are thus guaranteed.

The synthetic hot glue which is used is preferably water-free and consists, for example, of 100% thermoplastic material, of which, for example, 40% may be a polymer material, 35% a resin and 25% a wax. The viscosity and general processing properties which are required for a given example of application are determined by the wax content. The resin content is responsible for rapid initial adhesion with sufficient adhesive strength, while the polymer content provides a high final bonding strength, i.e. load-bearing capacity of the set adhesive joint.

According to a preferred embodiment of the method according to the invention, the synthetic hot glue is applied in a flat manner to the first sheet, for example by means of an applicator roll or by spraying with nozzles. However, according to the application, other developments are possible in which the hot glue can be applied to the first sheet, for example, in a punctual manner, linear manner or in the form of a predetermined pattern in order to reduce the glue consumption still further.

The first sheet is preferably a so-called bottom sheet and the second sheet preferably a so-called top sheet which is laminated onto the top side of the first sheet.

In the method according to the invention, a face of the second sheet, i.e. of the paper sheet, is printed in many cases. When producing puzzles, for example, the face of the second sheet bears the motif which is the subject matter of the puzzle. Another example is constituted by table games with a “board”, in the case of which the face of the second sheet bears the game plan. Yet a further example is found in playing card games, as are sold under the known trademark Memory® of the company Ravensburger and in the case of which the face of the second sheet bears the motifs which are to be found in pairs in the course of the game.

If the other side of the first sheet is also to be laminated, then the face of the third sheet which is used for this purpose is as a rule likewise printed. It may, for example, bear a further game plan or may simply be printed in a decorative manner, for example with the name of the manufacturer of the game.

When producing puzzles, but not only in this case, individual parts must be produced from the two sheets which are bonded together. This preferably takes place by way of stamping or cutting, whereby a plurality of regularly or irregularly shaped parts are obtained from the finished laminated product. If the individual parts are produced by way of stamping, then this stamping advantageously takes place in a single step, i.e. a stamping both in the transverse direction and in the longitudinal direction is produced with a single stamping process. When producing puzzles this single stamping process then results in a plurality of irregularly shaped parts, which in their totality form the puzzle. In the case of a playing card game the small playing cards are obtained by way of the stamping or cutting processes.

According to a particularly preferred embodiment, the method according to the invention is used to produce a puzzle. For this purpose a bottom sheet of cardboard is transported via a feeder in a laminating machine to a gluing mechanism of the laminating machine. In the gluing mechanism a synthetic hot glue is supplied at a temperature of approximately 150° C. to approximately 180° C. in liquid form and applied to the top side of the bottom sheet by means of an applicator roll. The bottom sheet coated with the hot glue is then transported to an aligning station, to which a top sheet consisting of paper or cardboard is also guided by means of a further feeder, the face of which sheet is printed with the puzzle motif. The top and bottom sheets are brought together in the aligning station and then stuck together by pressing them together. The products which are finish-laminated in such a way are stacked on a pallet in a delivery station and subsequently brought to a stamping machine in which each individual finished laminated product is cut by way of a single stamping process into a plurality of irregularly shaped puzzle parts. If necessary or desired, the finished laminated product can be trimmed prior to the stamping process. The stamped laminated product is then guided over a toothed roller in order to detach the individual puzzle parts from one another, after which these fall into a plastic bag which, after being closed, is fed to a packaging station in which the puzzle parts located in the bag are associated with the corresponding product packaging.

According to another preferred embodiment, the method according to the invention is used to produce a game plan as is required for many table games, for example. The individual manufacturing operations correspond to the steps indicated previously in connection with the puzzle production, although the stamping of the finished laminated product into a plurality of irregularly shaped puzzle parts does not apply, the finished laminated product at the most being scratched or grooved in a linear manner at predetermined points in order to enable a folding game plane to be formed.

1. A method for bonding together at least two sheets, in particular for producing a puzzle, of which a first sheet consists of cardboard or paperboard and a second sheet consists of paper or cardboard, comprising the steps:
transporting the first sheet to a gluing station,
applying a glue to one side of the first sheet in the gluing station in the liquid state,
bringing together the first sheet coated with the glue and the second sheet in an aligning station, and
pressing the two sheets together to form a finish-laminated product, characterised in that the glue is a water-free synthetic hot melt which consists of 100% thermoplastic material.

2. The method according to claim 1,
characterised in that a synthetic hot melt is also applied to the other side of the first sheet which is opposite the one side, and the first sheet is brought together with and bonded to a third sheet consisting of paper or cardboard.

3. The method according to claim 1,
characterised in that the synthetic hot melt is applied to the first sheet at a temperature in the range of approximately 150° C. to approximately 180° C.

4. The method according to claim 1,
characterised in that the hot melt is applied flat-wise to the first sheet.

5. The method according to claim 1,
characterised in that the first sheet is a bottom sheet and the second sheet is a top sheet.

6. The method according to claim 1,
characterised in that a face of the second sheet is printed.

7. The method according to claim 6,
characterised in that the two sheets which are bonded together are cut into a plurality of individual parts by way of stamping.

8. The method according to claim 7,
characterised in that the parts are irregularly shaped, and that the stamping takes place in a single step.

9. A Puzzle, characterised in that it has been produced using at
least two sheets bonded together by way of a method according to claim 1.

10. A game plan, characterised in that it has been produced using at least two sheets bonded together by way of a method according to claim 1.

11. The method according to claim 1, characterised in that the synthetic hot melt is applied to the first sheet at a temperature in the range of approximately 150° C. to approximately 180° C.

12. The method according to claim 2, characterised in that the hot melt is applied flat-wise to the first sheet.

13. The method according to claim 3, characterised in that the hot melt is applied flat-wise to the first sheet.

14. The method according to claim 2, characterised in that the first sheet is a bottom sheet and the second sheet is a top sheet.

15. The method according to claim 3, characterised in that the first sheet is a bottom sheet and the second sheet is a top sheet.

16. The method according to claim 4, characterised in that the first sheet is a bottom sheet and the second sheet is a top sheet.

17. The method according to claim 2, characterised in that a face of the second sheet is printed.

18. The method according to claim 3, characterised in that a face of the second sheet is printed.

19. The method according to claim 4, characterised in that a face of the second sheet is printed.

20. The method according to claim 5, characterised in that a face of the second sheet is printed.
